(19) United States
(12) Patent Application Publication
(10) Pub. No.: US 2003/0063772 A1
(43) Pub. Date: Apr. 3, 2003

(54) System and method for authentication and tracking of a workpiece that includes an optically active medium

(76) Inventors: Joshua R. Smith, Cambridge, MA (US); Eric Metois, Arlington, MA (US); Michael J. Murphy, Salem, NH (US)

Correspondence Address: CESARI AND MCKENNA, LLP, 88 BLACK FALCON AVENUE, BOSTON, MA, 02210, US

(21) Appl. No.: 10/236,697

(22) Filed: Sep. 6, 2002

Related U.S. Application Data
(60) Provisional application No. 60/317,665, filed on Sep. 6, 2001.
(60) Provisional application No. 60/394,916, filed on Jul. 10, 2002.

(51) Int. Cl. G06K 9/00

(52) U.S. Cl. 382/100

(57) ABSTRACT

An inhomogeneous, optically active medium with optically active components, such as, an ink with reflective flakes or a gemstone dust, is included on or embedded in one or more portions of a workpiece. When the portions are illuminated with visible and/or ultraviolet light, the components, which are also anisotropic, provide readily detectable information that can be extracted for a string which is included on or associated with an indicium that is used to authenticate the workpiece. To verify the workpiece, the one or more portions that contain the optically active medium are again illuminated, and the string is then newly generated from various images of the appearances of the components. The newly generated string or, as appropriate, an indicium that is based on the string is then compared with a string or an indicium that is imprinted on or associated with the workpiece. If the previously and newly generated strings or indicium correspond, the workpiece is determined to be authentic. Otherwise, the workpiece is deemed to be a counterfeit.

### CROSS-REFERENCE TO RELATED APPLICATIONS

This application claims priority from U.S. Provisional Patent Application Serial No. 60/317,665 filed Sep. 6, 2001 entitled SYSTEM AND METHOD FOR AUTHENTICATION AND TRACKING OF A WORKPIECE THAT INCLUDES AN OPTICALLY VARIABLE MEDIUM and U.S. Provisional Patent Application Serial No. 60/394,916 filed Jul. 10, 2002 entitled WORKPIECE AUTHENTICATION AND TRACKING USING GEMSTONE DUST.

This application is also related to U.S. patent application Ser. No. 09/719,430 filed Dec. 12, 2000, entitled WORKPIECE AUTHENTICATION BASED UPON ONE OR MORE WORKPIECE IMAGES, which has a common assignee and is incorporated herein by reference.

### BACKGROUND OF THE INVENTION

1. Field of the Invention

The present invention relates generally to workpiece authentication techniques, and more specifically, to such techniques which involve imaging one or more portions of the workpiece to generate abstractions (e.g., numeric or alphanumeric strings) which represent random physical characteristics of an optically active medium included on or embedded in the workpiece, and using the abstractions to determine whether the workpiece is authentic.

2. Brief Description of Related Prior Art

A value indicium is a symbol or token that indicates payment for a service. One example of a commonly-used value indicium is the “franking” or postal meter mark, which is placed on a postal mailpiece to indicate that a specified amount of money has been paid to post the mailpiece. Other examples of value indicia include paper currency, money orders, and tickets for cultural events and transportation.

Authentication indicia are symbols or tokens placed on or in a workpiece for use in determining the validity of the workpiece (e.g., whether the workpiece is authentic, as opposed to being a forgery). For example, legal documents, such as passports and driver's licenses often have validation stamps/seals from a certifying authority (CA), such as the government, placed on them that vouch for the authenticity of the legal documents.

In the past, if a postal franking mark on a postal mailpiece appeared to the ordinary observer (e.g., a postal clerk) to have been made by an authorized postal franking device, the mailpiece would be considered valid and would be posted without further inquiry into whether the mark was genuine. Unfortunately, improvements in photo-copying, computer-based imaging and duplication technologies have rendered this prior art authentication technique unreliable, as they have permitted the unscrupulous to produce high quality forgeries of such franking marks that often appear genuine to the ordinary observer. This has driven interest in creating a postal franking mark whose authenticity can be determined without reference to its appearance, but instead can be determined using different criteria.

In one such conventional validation technique, the franking mark comprises an indicium that contains certain identifying information, such as the postage purchase date, meter identification number, franking sequence number, source and destination addresses of the mailpiece, and a cryptographic signature of the identifying information. According to this technique, mailpiece forgeries are detected based upon whether differences exist between the identifying information and the cryptographic signature in the indicium, and the actual identifying information of the mailpiece and the actual cryptographic signature of such actual identifying information.

Unfortunately, this latter validation technique is unable to thwart certain types of postal franking fraud. For example, if the identifying information and signature of a valid indicium of a first mailpiece are also valid for a second mailpiece, then the indicium of the first mailpiece may be fraudulently copied onto the second mail piece, and the fraudulent copying cannot be detected using this technique. Hereinafter, this type of fraud will be termed “double spending fraud.”

Additionally, advances in networking technology have also permitted wide access to the data underlying such franking marks. For example, one could download such data using the Internet from a computer node storing such data (e.g., via email or a World Wide Web posting), and depending upon the manner in which this conventional technique is implemented, a large number of seemingly valid franking marks could be generated based upon such data. This further exacerbates the possibility and opportunity for such fraud.

In one prior art technique that is used to try to thwart double spending fraud, a database tracks use of value indicia and the respective identifying information therein. If two mailpieces have identical indicia, the database indicates this as a possible occurrence of double spending fraud.

Unfortunately, in practical implementation, this conventional double spending fraud detection technique requires use of a large database to track the indicia's identifying information. Disadvantageously, the burden and expense of maintaining and querying such a large database is undesirable. Also disadvantageously, this conventional fraud detection technique does not permit off-line verification of the indicia (i.e., not based upon information obtained via a network), and no mechanism is provided in this technique to determine which indicium among indicia determined to be identical is authentic.

Another prior art fraud problem arises when unauthorized use is made of data or digital tokens (e.g., stored in a computerized postal franking system's internal memory) that when supplied to the system cause it to produce otherwise valid authentication indicia.

To aid in authenticating credit cards, documents and products, optically variable devices such as holograms may be included on the workpiece. The optical variable devices are useful because their color shifting properties cannot be duplicated by a photocopying process. Further, the optically variable properties can easily be detected by the human eye. When, for example, the viewing angle changes, the hologram exhibits color and parallax shift.

One of the disadvantages of holograms for security applications is that there is no widely available “variable printing” technique for mass-producing unique holograms, that contain, for example, a serial number, a unique barcode, an authentication code or a digital signature. Thus, the hologram does not allow documents to be uniquely identified, and cannot be used for security applications, such as, maintaining audit trails or detecting copies. A further disadvantage of holograms for document security applications is that the structure of the hologram can be degraded through mechanical wear and tear, such as the folding and unfolding of the document.

One solution to the problem of hologram wear and tear that is known in the art is the use of inks or paints with interspersed flakes of color shifting multilayer interference film, as disclosed in U.S. Pat. No. 6,236,510B1, or flakes of bright metal, as in U.S. Pat. No. 6,013,370. Such films have optically variable or color-shifting properties, like holograms, but are more robust because the paint or ink can flex, while the small optically variable flakes remain rigid, to maintain their optical characteristics.

The properties of inks with embedded optical flakes are such that they cannot currently be variably printed to create unique patterns. Like a hologram, the inks are associated with mass produced, identically printed patterns. Both the holograms and the identically printed patterns of optically variable ink thus suffer from the limitation that anyone in possession of the means to produce or reproduce the optically variable property is in principle able to produce counterfeit articles that are visually indistinguishable from genuine articles.

### SUMMARY OF THE INVENTION

In accordance with the present invention, a workpiece authentication technique is provided that overcomes the aforesaid and other disadvantages of the prior art. A first aspect of the present invention provides an authentication indicium, using this technique. In one embodiment of the indicium, the indicium is placed on a workpiece for use in determining the workpiece's validity. The indicium comprises a set of one or more markings that correspond to or represent a numeric or alphanumeric string and/or an “information security signature,” such as, for example, a cryptographic signature from a certifying authority (CA). The signature is based at least in part upon the string and, in the example, a cryptographic key belonging to the CA. If the workpiece is valid, the string is based upon, at least in part, intrinsic optical characteristics of an “optically active medium” that is included on or embedded in one or more portions of the workpiece.

The optical characteristics are represented by one or more images that depend on the relative orientations, positions, and/or patterns of “optically active components” included in the optically active medium and/or the positions, orientations or patterns of the surface geometry, for example, the profile, of the optically active medium included on or embedded in the one or more portions of the workpiece. The one or more images consist of patterns that are the result of light that is diffracted, reflected and/or emitted by the optically active medium in response to the illumination of the one or more portions. The term “optically active medium” as used herein refers to a medium that has optical properties that represent various degrees of freedom on a microscopic level. The degrees of freedom may be associated with features of the surface geometry of the medium that have irregular shapes and/or essentially random relative positions, orientations and so forth, and which produce various diffraction patterns in the images. Alternatively, or in addition, the degrees of freedom may be associated with features of the one or more optically active components that similarly have irregular shapes and/or essentially random relative positions, orientations and so forth, and produce various patterns of reflected, diffracted and/or emitted light. The “optically active components” may be reflective flakes included in an optically variable ink, reflective and/or fluorescent gems included in gemstone dust, and so forth. The features of the optically active medium that produce the patterns in the image, i.e., the irregularities in surface geometry and/or the optically active components, are hereinafter referred to collectively as the “optically active aspects.”

The indicium one or more markings may comprise human and/or machine readable sequences of characters, such as one or more barcodes, sequences of digits, spread-spectrum markings and/or machine readable printed symbology such as angular symbology, which is described in United States patent application Ser. No. 09/921,172 entitled DATA ENCODING AND DECODING USING ANGULAR SYMBOLOGY, filed Aug. 2, 2001, which assigned to a common assignee.

The workpiece may be a postal mailpiece, a security label, a certificate of authenticity, an identification card, a credit card, and so forth. If the workpiece is a valid postal mailpiece, the indicium may be printed on the mailpiece by an apparatus (e.g., a postal franking apparatus), and the string also may be representative of or comprise a postage value associated with the mailpiece (i.e., an amount of money paid to post the mailpiece) and/or an identification number used to identify the apparatus. The string may also be based upon respective numerical values (e.g., representative of one or more hash values) representative of the postage value and/or an apparatus identification number. If the workpiece is a valid security label or certificate of authenticity, the string may further be representative of the associated product or document, e.g., include a product or document serial numbers and so forth. If the workpiece is a valid identification card or credit card, the string may be further representative of the user and/or the provider of the card or associated services, e.g. include a user or provider ID.

The string may also be based upon, at least in part, a concatenation of a plurality of numerical hash values derived from the one or more images, or differences between or among such images. The one or more images may be generated by an imaging device having a radiation sensing element or elements that may consist of a linear array of photosensing elements, a two-dimensional array of photosensing elements, or a single photo-sensing element. The imaging device may generate the images by scanning the one or more portions of the workpiece in accordance with imaging registration or fiducial marks on the workpiece. The photosensing element or elements of the imaging device may be integrated into or comprised within a mechanism for printing the indicium on the workpiece.

Apparatus and methods are also provided which implement aspects of the present invention. One embodiment of an apparatus according to a second aspect of the present invention is used to generate an indicium according to the present invention, and to place the generated indicium on a workpiece; an embodiment of an apparatus according to a third aspect of the present invention is used to analyze a workpiece and an indicium already present on the workpiece to determine whether the workpiece is authentic.

In each of these embodiments of the apparatus according to the second and third aspects of the present invention, the apparatus generates a string for use in determining whether the workpiece is valid. The apparatus includes an electromagnetic radiation source that illuminates one or more portions of the workpiece with electromagnetic radiation from one or a plurality of illumination positions relative to the one or more portions of the workpiece. An imaging device comprised in the apparatus generates respective images of the relative orientations, positions and/or patterns of the optically active aspects included in the one or more portions of the workpiece, when the one or more portions of the workpiece are illuminated with the radiation. A string generating mechanism generates the string based upon, at least in part, the respective images generated by the imaging device.

More specifically, an inhomogeneous, optically active medium, such as the ink with embedded reflective flakes, is included on or embedded in one or more portions of the workpiece. When the portions are illuminated, the included optically active components, which are anisotropic, provide readily detectable information that can be extracted for the strings. The information corresponds to various degrees of freedom associated with the components.

If, for example, the flakes are planar and are not oriented parallel to the substrate plane, each flake, in principle, possesses two continuous degrees of freedom, namely, azimuthal and elevational orientation, in addition to a presence/absence degree of freedom. If the flakes exhibit orientational anisotropy, additional information may be extracted from the substrate by illuminating from a first direction and collecting an image, illuminating from a second direction and collecting a substantially different image, and so forth. Using a mixture of different flake types consisting, for example, of different thin film dimensions, and thus, different colors, yields additional degrees of freedom that may be sampled, i.e., the color of each sampled image pixel may differ. The colors of the flakes, and thus the sampled pixels, vary further when different illuminating and/or viewing angles are used. In addition, if the flakes are asymmetrical, with different thin film dimensions on the top and bottom side of the metallic reflector layer, then the “up” or “down” orientation is another degree of freedom that may be represented in or affect the data in the string.

The optically active components may be gems that are included in gemstone dust. As discussed in more detail below, the respective gems, which are selected by sorting to have similar sizes, have irregular shapes and also random positions within the dust. The positions and shapes of the gems are thus associated with various degrees of freedom. In addition, the gems may emit visible light in particular wavelengths when the dust is illuminated by ultraviolet light. Thus, combinations of different gems in the dust emit light of different wavelengths, that is, of different colors, for additional degrees of freedom.

As discussed, the optically active medium may instead be a homogenous material that, because of the manner in which the material is applied to the workpiece, has a surface geometry with inherent features, or irregularities, that exhibit the same randomness as the optically active components, such that the surface geometry produces unique associated diffraction patterns when illuminated.

The large contrast-to-noise ratio of signals derived from the optically active aspects, plus the high information density and the robustness to physical degradation of the optically active media yield benefits to authentication, such as the long lifetime of the feature used for authentication, the relatively small sample areas required to produce long strings that can then be used to authenticate or identify large numbers of articles, and so on. Further, the media have human checkable features, namely, the presence or absence of the optically active property, that can be used to eliminate crude frauds.

As compared with the optically variable device art, the present invention enables a more definitive machine checkable security mechanism than simple appearance. The verification device can determine whether the particular detailed pattern of bright reflective or emitted highlights is correct, and it will not be fooled by substitution of, for example, one hologram for another of similar optical properties. Furthermore, it becomes possible to track the individual articles using the characteristics of the optically active media that are included on or embedded in the respective articles. This is true even though there may be no room on the article to print, for example, an identifying indicium, such as a bar code.

These and other features and advantages of the present invention will become apparent as the following Detailed Description proceeds and upon reference to the Drawings, in which:

### BRIEF DESCRIPTION OF THE DRAWINGS

FIG. 1 is a highly schematic representation of the layout and elements comprised in a front surface of a mailpiece having one embodiment of an indicium in accordance with the first aspect of the present invention.

FIG. 2 is a highly schematic representation of a portion of the mailpiece of FIG. 1.

FIG. 3 is a highly schematic representation of a variation of the portion of the workpiece shown in FIG. 2.

FIG. 4 is a functional block diagram illustrating the construction of one embodiment of an apparatus according to the second aspect of the present invention.

FIG. 5 is a schematic representation of a security label that includes an optically active medium and a security seal;

FIG. 6 is a functional block diagram illustrating the construction of one embodiment of an apparatus according to the third aspect of the present invention.

FIGS. 7 and 8 are functional block diagrams illustrating positions of elements of the apparatus of FIGS. 4 and 6 relative to the mailpiece of FIG. 1 when the apparatus are in use.

FIG. 9 is a schematic representation of a card with an optically active medium embedded therein.

FIG. 10 is a highly schematic representation of an alternative card;

FIG. 11 is a functional block diagram of a verification device for use with the cards of FIGS. 9 and 10.

FIG. 12 is a functional block diagram of an alternative verification device.

FIG. 13 is a digital photographic image of the card of FIG. 9 illuminated from a rear side.

FIG. 14 is a digital photograph of a top view of a token that has a top layer of an optically active medium.

FIG. 15 is an exploded highly schematic representation of the token of FIG. 14.

Although the following Detailed Description will proceed with reference being made to illustrative embodiments and methods of use, it will be appreciated by those skilled in the art that many alternatives, modifications, and variations thereof are possible without departing from the present invention. Thus, it is intended that the present invention should be viewed as encompassing all such alternatives, modifications, and variations as will be apparent to those skilled in the art, and should be defined only as set forth in the hereinafter appended claims.

### DETAILED DESCRIPTION OF AN ILLUSTRATIVE EMBODIMENT

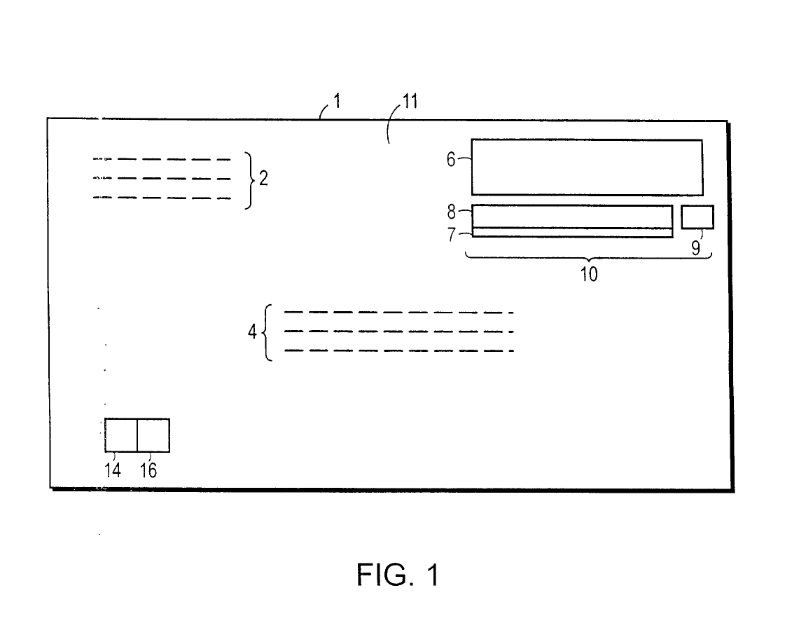

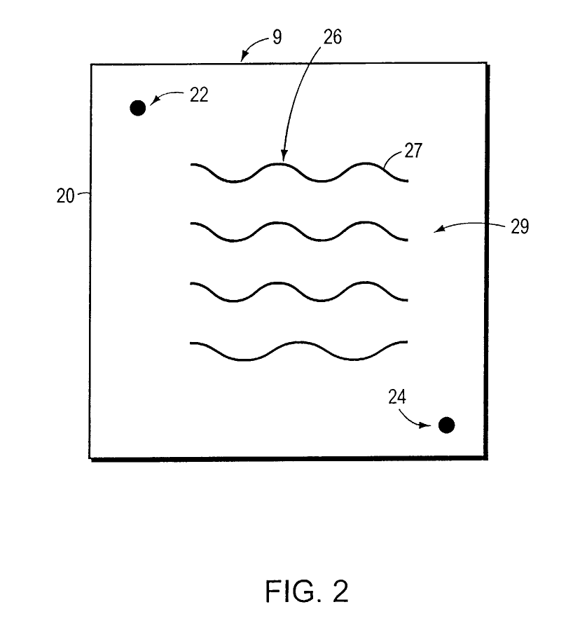

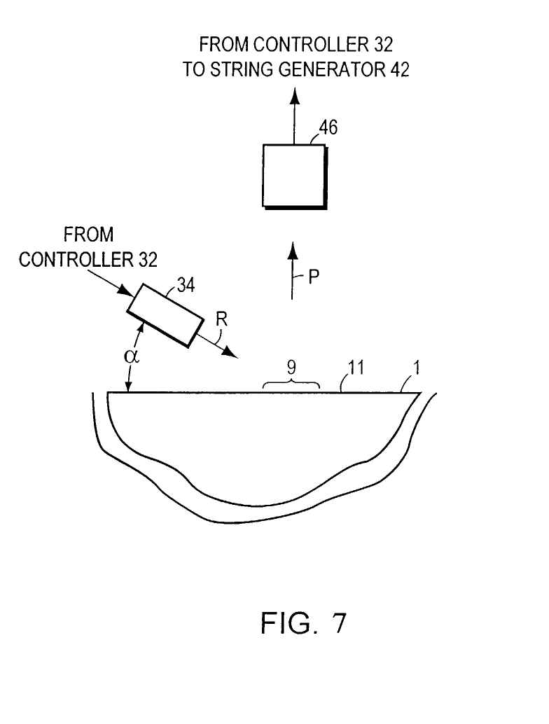

With reference being made to FIGS. 1-7, illustrative embodiments of aspects of the present invention will now be described. FIGS. 1-2 illustrate features of a workpiece 1 that includes one embodiment of an authentication indicium 10 made according to one aspect of the present invention. More specifically, in FIGS. 1-2, workpiece 1 is a postal mailpiece that comprises a postal envelope whose front outer surface 11 includes indicium 10. Surface 11 also comprises written postal source address 2 (i.e., of the sender of mailpiece 1) and destination address 4 (i.e., of the intended recipient of mailpiece 1) in the upper left corner and center, respectively, of the surface 11 of mailpiece envelope 1. A postal symbol or artistic graphic 6 may also be placed on the surface 11 (e.g., in the upper right corner of surface 11 above the indicium 10, as shown in FIG. 1).

In accordance with this embodiment of this aspect of the present invention, indicium 10 includes respective markings 7, 8 provided on surface 11 of the envelope 1. Markings 7 comprises a human-readable alphanumeric text disclosing to a human reader information that is pertinent to the mailpiece 1. The markings may include, for example, the amount of postage that has been paid to post the mailpiece 1 and the city and/or country from which the mailpiece 1 is being posted. Markings 8 are a human or machine readable uni- or multi-dimensional bar code and/or sequence of human-readable digits that correspond to or represent a “information security signature,” and/or a numeric or alphanumeric string. The term “information security signature” refers to a code word that can be used to verify the validity of the workpiece. The use of markings 8 of indicia 10 in accordance with aspects of the present invention, to determine validity of the workpiece 1 is discussed in more detail below.

As shown in FIG. 2, markings 9 comprise a fiducial square or box 20 that encloses a portion 39 of workpiece 1 in which an optically active medium is included on the surface 11 or embedded in the workpiece. Two fiducial points or dots 22, 24 are located at diagonally-opposite corners of box 20. Each of the dots 22, 24 is spaced away from a respective corner of the box 20 by an identical distance.

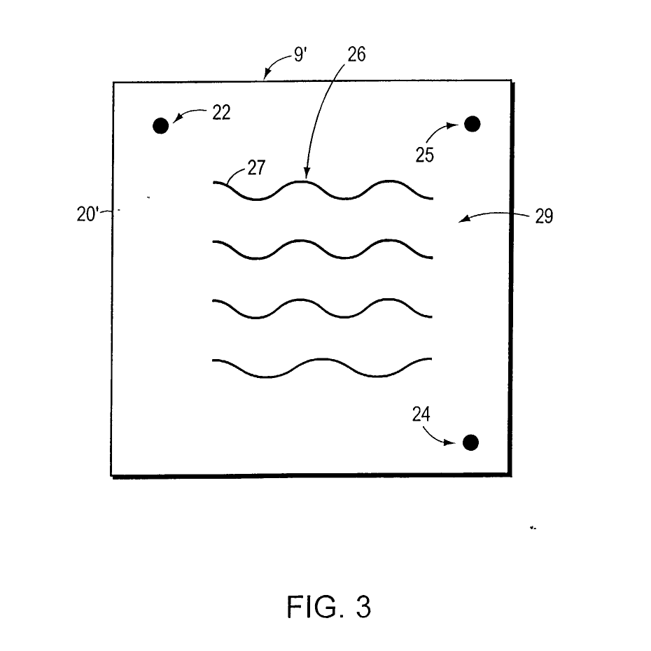

Alternatively, as is shown in FIG. 3, marking 9 may be replaced with markings 9'. Markings 9' include a fiducial square or box 20' that encloses the portion 29 of the workpiece 1, and three fiducial dots 22, 24, 25. The dots 22, 24, 25 are respectively located adjacent respective corners of the box 20'. More specifically, each of the dots 22, 24, 25 is spaced away from a respective corner of the box 20' by an identical distance. Additionally, the distance between dots 22 and 25 is the same as the distance between dots 24 and 25, respectively.

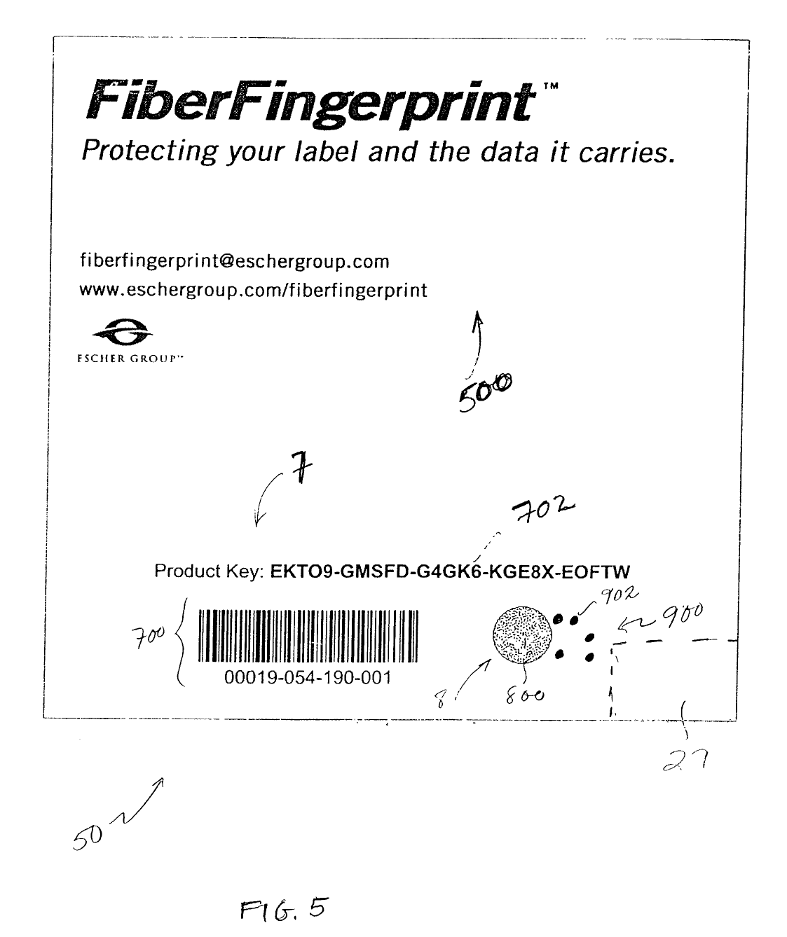

The markings 9 or 9' may instead be in the form of a constellation 900 of dots 902 FIG. 5, that indicates the location and orientation of the portion 29, without forming a box or other enclosure around the portion.

As noted previously, markings 8 may correspond to or represent a unique “information security signature” and/or a numeric or alphanumeric string. The information security signature may be a signature that is produced by an asymmetric cryptographic technique, including encryption or digital signatures, such as, a cryptographic signature, which is the result of encrypting or signing the string using one cryptographic key of a private/public cryptographic key pair of a CA (e.g., a governmental authority, such as the U.S. Postal Service) in accordance with well known conventional private/public key encryption techniques. The information signature may instead be a signature that is produced by symmetric encryption of the string, or a signature that corresponds to a code word that is randomly assigned to the workpiece by, for example, the manufacturer. In addition, the string itself may be encrypted to add further protection. The use of the randomly assigned code word for validation of the workpiece is discussed in more detail below with reference to FIG. 5.

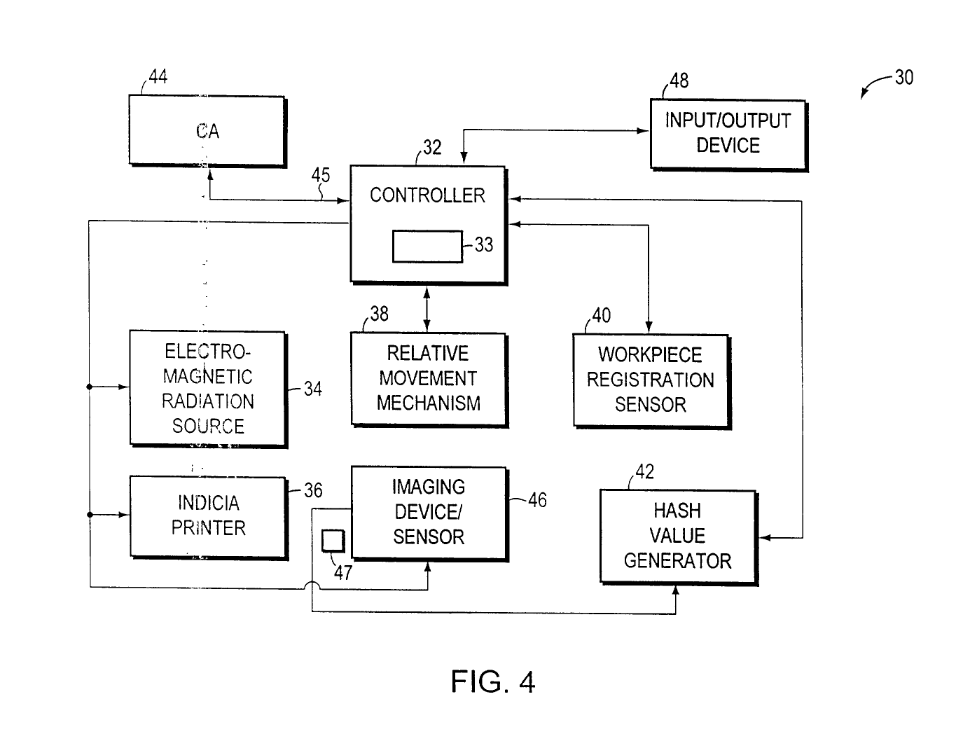

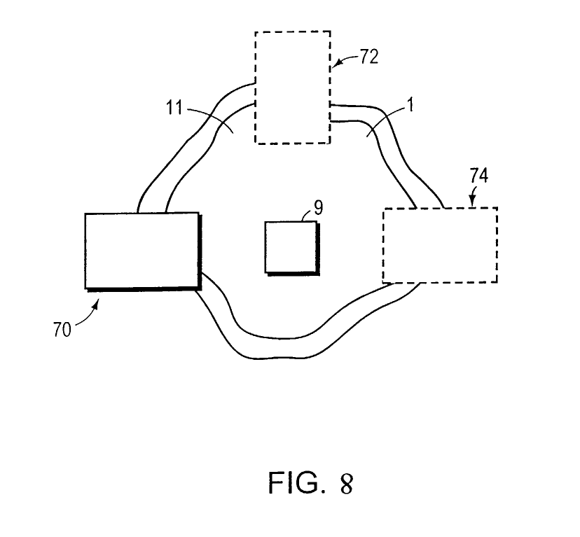

As will be described more fully below, if the mailpiece is valid/authentic, the string being represented by or corresponding to the markings 8 is based upon, at least in part, certain random, intrinsic optical characteristics (symbolically referred to by numeral 26) of an optically active medium that is included on or embedded in the portion 29. As discussed in more detail below with reference to FIG. 8, the optically variable medium may instead be encased in one or more portions 30 of the workpiece. The optical characteristics 26 include respective images (referred to by numeral 47) of relative orientations, positions and/or patterns of optically active aspects of the optically active medium. The images are produced when the portion 29 is illuminated with electromagnetic radiation R from one or a plurality of illumination positions 70 (see, FIGS. 4-7). The features captured in the image are referred to collectively hereinafter as “aspect appearances” and denoted by the numeral 27. As will be described more fully below, the string represented by or corresponding to markings 8 is based upon or derived from respective images 47 of the aspect appearances 27 that are associated with the portion 29. As used herein, the term “image” may include any combination of one and/or two-dimensional samplings of reflected or emitted radiation from the surface 11.

The aspect appearances 27 include details of certain readily observable or microscopic phenomena that are random and result from intrinsic two or three dimensional properties of the optically active aspects of the optically active medium that is included on or embedded in the portion 29. Such microscopic phenomena may include e.g., the respective orientations, positions and/or patterns of the optically active components and/or the irregularities in the geometry, which are determined based on the corresponding reflections or emissions.

The optically active medium may, for example, be an optically variable ink that contains optically variable flakes. The optically variable flakes can be highly reflective and thus the presence or absence of certain or all of the respective flakes is readily seen in or read from the portion 29, after the portion is illuminated. Further, the flakes are anisotropic and if the flakes are also planar and not oriented parallel to the substrate plane, the respective flakes, in theory, possess two additional degrees of freedom, namely, azimuthal and elevational orientation, that can be detected by illuminating the portion 30 from a single direction and collecting a first image 47. If the flakes also exhibit orientational anisotropy, additional information may be extracted by illuminating the portion 29 from a second direction, collecting a substantially different image 47, and so forth. Due to diffractive effects, shifts in illuminating or viewing angles may produce color shifts, and thus, provide additional information that may be extracted.

An optically variable ink that includes a mixture of different flake types consisting of, for example, different thin film dimensions, and thus, different colors and/or shapes, yields additional degrees of freedom. If the flakes are also asymmetrical, i.e., have different thin film dimensions on the top and bottom side of the metallic reflector layer, the “up” or “down” orientation is an additional degree of freedom that may be measured also by differing colors of the sample pixels. Further, illuminating or viewing the various types of flakes from different angles results in varying colors for the respective types of flakes. With so much information available from the optically variable components, the size of the portion 29 may be relatively small.

The optically active medium may be instead or in addition a gemstone dust that is embedded in or on one or more portions of a workpiece. The optically active components in the dust are randomly positioned, irregularly shaped gems, which are sorted or strained to be of a particular average size. One example of a gemstone dust is ruby dust, which is also used in industrial applications. As discussed in more detail with reference to FIG. 8 below the positions of the respective gems, the shapes of the gems, and the associated light emitting properties of the individual and the collective gems all represent associated degrees of freedom.

Referring again to FIGS. 1-7, the string that is included in or associated with the markings 8 comprises a numerical hash value that is computed using a predetermined hashing algorithm, which operates upon numerical values that are representative of the images 47. Hashing algorithms are traditionally selected such that they generate identical respective hash values when supplied with identical respective groups of images 47. However, probabalistic algorithms may also be selected.

One example of a traditional hashing algorithm is the identity function. Thus, images 47 may be converted into respective sets of numerical values (i.e., digitized), the sets of numerical values may be concatenated with each other, and the value of the resulting concatenation may serve as the hash value. In practice, however, it will usually be desirable to employ a hashing algorithm that compresses (i.e., reduces the amount of data comprised in the sets of numerical values). For example, binary thresholded versions of the sets of numerical values may be concatenated to form the hash value, although typically much more compression will be desired. Alternatively, the sets of numerical values may be compressed with a lossy compression algorithm, such as JPEG or wavelet compression, and concatenated. Also alternatively, in practice, a small number of coefficients from discrete cosine transforms, discrete Fourier transforms, or wavelet transforms of the sets of numerical values may be used to form the hash value.

Further alternatively, the hash value may be generated using an algorithm that first extracts from the digitized images respective rectangular image portions of predetermined size (e.g., respective digitized image data corresponding to the respective image regions). These image regions may be 10 pixel rows by 200 pixel columns in size. Each of the image portions may then be scaled to a desired size, and undergo low pass filtering that permits verification using the ultimately-generated hash value that are less sensitive to noise-related errors. This low pass filtering may comprise a transverse low pass filtering which is accomplished by averaging pixel illumination values in respective columns along respective columns of the respective scaled images, and using the average pixel illumination values generated as values for pixels in a resulting transversely low pass filtered image.

More specifically, the respective average pixel values are used as the respective values of pixels in the filtered image that correspond to the respective first pixel values in the respective columns used to generate the average pixel values. The averaged columns may each have the same size (e.g., 10 pixel values). Respective corresponding regions are then extracted from the transversely low pass filtered images (e.g., corresponding regions of 1 pixel by 100 pixels). These extracted regions then undergo a longitudinal high pass filtering. The high pass filtering may be accomplished by longitudinally low pass filtering the extracted regions and then subtracting corresponding pixel values of the longitudinally low pass filtered images from the respective, original extracted regions from which they were generated. The resulting high pass filtered images may then undergo binary thresholding, and the respective numerical values generated therefrom may be concatenated to form the hash value.

In order to decrease the size of the resulting hash value, and increase the discriminatory power of each bit of the hash value a majority of the pixels comprising the images 47 may be ignored when calculating the hash value. For example, the images may be broken down into groups of contiguous pixels (e.g., 5 contiguous pixels), and in each such pixel group, only a single corresponding pixel may be used in generating the hash value.

Additional techniques for generating the hash value include basing the hash value upon pairwise differences of corresponding pixel illumination values of pairs of images, sequential differences of these corresponding illumination values, and/or principle components representations of the images.

FIG. 4 is a functional block diagram of one embodiment of an apparatus 30 for generating and placing marks 7, 8 of indicium 10 on surface 11 of envelope workpiece 1. As shown in FIG. 4, apparatus 30 includes controller 32. Controller 32 includes computer-readable memory 33 (e.g., comprising random access, read-only, and/or mass storage memory) for storing software programs and associated data structures for execution by one or more processors also comprised in controller 32 and/or other elements of apparatus 30. When executed by the one or more processors in apparatus 30, the software programs and data structures cause the controller 32 and other elements of apparatus 30 to carry out and/or implement the techniques, functions, and operations described herein as being carried out and/or implemented by controller 32 and other elements of apparatus 30. It will be apparent to those skilled in the art that many types of computer processors and memories may be used in controller 32 without departing from the present invention. For example, controller 32 may comprise one or more Intel 80X86-type processors and associated memory.

User input/output device 48 comprises a conventional mechanism for interfacing a human user (not shown) to the controller 32 so as to permit the user to control and monitor operation of apparatus 30. Device 48 may include, for example, one or more conventional computer-user interface devices, such as pointing and keyboard input devices, and a display output device which together permit the human user to input commands to controller 32 to be performed by apparatus 30, and to receive from controller 32 an indication of the progress of apparatus 30 in executing the input commands.

Apparatus 30 also includes a mechanism 38 for receiving the workpiece 1, in the example, an envelope, and for moving the envelope 1, to position the envelope 1 relative to an electromagnetic radiation source 34 and imaging device 46 in such a way as to permit generation of images 47 by device 46. More specifically, mechanism 38 comprises conventional electromechanical components that permit the envelope 1 to be physically inserted into mechanism 38, and thereafter, as appropriate to be moved relative to source 34 and device 46.

After envelope 1 is physically inserted into mechanism 38, mechanism 38 signals controller 32 that envelope 1 has been received by mechanism 38. In response to this signal from mechanism 38, controller 32 activates registration sensor 40. The sensor 40 comprises conventional components for optically scanning the envelope surface 11 and for determining, based upon such optical scanning, the position and orientation of registration marks 9 relative to the source 34 and device 46. At periodic time intervals after its activation, sensor 40 provides to controller 32 information concerning the position and orientation of the marks 9 relative to the source 34 and device 46 from which controller 32 may determine the registration of the portion 30 relative to the source 34 and device 46.

The controller 32 may use the registration information to determine the positions of coordinate axes in the associated images 47 and/or to determine which pixels are to be sampled to extract information for the images. Alternatively, or in addition, the controller 32 may provide commands to mechanism 38 that cause mechanism 38 to move the envelope 1 relative to the source 34 and device 46 such that the source 34 and device 46 are brought into an initial predetermined registration relative to the portion 30.

With the workpiece in place, the controller 32 determines the position of the centroid of the radiation sensing element(s) of the device 46 relative to the centroid of the portion 30, based on the relative locations of the registration marks 9. Under the direction of the controller 32, the source 34, which is in position 70, emits an electromagnetic beam of illuminating radiation R at a predetermined orientation a relative to the portion 29. The beam R of illuminating radiation strikes the optically active medium that is included on or embedded in the portion 29, and a portion P of the radiation beam R is reflected by the optically active aspects of the medium at an angle that is normal (i.e., perpendicular) to portion 29. This portion P of the radiation beam R is received by the sensing element(s) of device 46, which generate from portion P an image 47 of the aspect appearance 27. Device 46 then digitizes this image and supplies the digitized image to hash value generator 41. The hash generator 41 stores the digitized image in a computer-readable memory (not shown), and indicates to controller 32 that it has received and stored the digitized image.

As appropriate, the controller 32 causes the source 34 to illuminate the portion 29 such that the illumination beam has a different angle and/or orientation relative to the portion 29. The device 46 receives a portion P of the beam R that is reflected by the optically variable aspects and converts this portion P into another image of the component appearance 27 of the portion 29, and digitizes this image. The digitized image is then transmitted to the hash value generator 41, which stores the digitized image and indicates to the controller 32 that it has received and stored the digitized image.

As appropriate, the controller 32 again causes the source 34 to illuminate the portion 29 so as to produce another image 47 which is then digitized and provided to the hash value generator 41, and so forth.

After the generator 41 has stored the one or more images 47 of the component appearances 27, the generator generates a hash value, using one of the previously described hash value generation algorithms. The hash value generated by generator 41 is then transmitted to the controller 32.

In the example in which the workpiece 1 is a postal mailpiece, the controller 32 next retrieves from the memory 33 a previously stored identification number that is used to identify the apparatus 30, and receives from the I/O device 48 an associated postage value for the mailpiece 1. The controller 32 then concatenates the hash value with the apparatus identification number and the associated postage value, in a predetermined fashion, so as to enable each of these values (i.e., the hash value, apparatus identification number, and postage value) to be extracted from the resultant concatenation when a predetermined extraction algorithm is applied thereto. Other values, (e.g., indicium version number, algorithm identification number, postal service device serial number, manufacturer identification number, apparatus model identification number, date of posting, ascending and descending register value, license post office zip code, apparatus software version identification number, destination delivery point code, and/or mail category/class code, may also be so concatenated with the hash value. The controller 32 then causes a printing mechanism 36 to print markings 8, which correspond to or represent the resultant concatenation of the apparatus identification number, postage value, and hash value.

Alternatively, the string once generated may be uploaded to the certifying authority 44 via network 45. The certifying authority 44 may then cryptographically sign or otherwise generate an information security signature for the string provided to it by the controller 32 of apparatus 30, and may return the signed string to the controller 32 via the network 45.

If the controller 32 and memory 33 of apparatus 30 are tamper-resistant, the cryptographic key used to sign the string may instead be stored in memory 33. The controller 32 then causes print mechanism 36 to print markings 8 that correspond to or represent the cryptographically signed concatenation and decrement a maximum postage value stored in the tamper-resistant memory.

The controller 32 may also cause printer 36 to place marks 7 onto the surface 11 of the mailpiece 1. The information represented by the one or more marks 7 may be supplied to the controller 32 by a human user via device 48 and/or may be prestored in memory 33 and retrieved therefrom by controller 32. The information comprised in the string may be transmitted to the CA for storage in a database for use in ensuring that the purchaser of postage is properly charged for the postage being used to post the mailpiece 1, and for other purposes that will be described below. Alternatively, or in addition thereto, the user of apparatus 30 may be required to log onto network 45 and to provide via network 45 information necessary to ensure identity of the user and the postage value prior to receiving the signed string from the CA to ensure proper charging of the postage to the user.

Referring now to FIG. 5, a product or document security label 50 includes markings 8 that include a machine printable and readable security seal 800. The seal includes a string which is based, at least in part, on the images 47 that correspond to the portion 29. The string is recorded on the label using angular symbology, but may be recorded using other machine printable and/or readable techniques. The markings 8 are based, at least in part, on images that are generated by illuminating a portion 29 of the label, which includes on or has embedded therein an optically active medium, such as, the optically variable ink that, for example, coats all or the portion 29. The portion 29 may be, for example, a section of the lower right corner (denoted by dotted lines), of the label 50. A constellation 900 of dots 902, which is strategically positioned relative to the portion 29, denotes the location and orientation of the portion 29. The constellation 900, or the various dots 902 thereof, need not be printed adjacent to the portion 29, and may instead be distributed over the workpiece. For example, the constellation 900, or the various dots 902 thereof, could be on top of the portion 29. The dots must, however, have a known relationship to the portion.

Markings 7 consist of a product serial number that is represented by a barcode and an associated numerical sequence 700, and a product key 702, which is an alphanumeric sequence that is randomly assigned to the associated product by, for example, the manufacturer. As discussed in more detail below the serial number 700 and the product key 702 may be used to aid in authenticating the label. The label 50 further includes printing denoted by the numeral 500, which consists of general label and/or product information.

The seal 800 includes a string that represents the hash value produced by the hash value generator 42, after the imaging device has provided digitized images to the generator, as discussed above with reference to FIG. 4. The string is further based, at least in part, on the serial number and the product key, which is essentially an information security signature.

The label 50 provides two security features, namely, a serial number/product key pairing and the security seal 800 which includes a string that is based on optical characteristics of the label and may be further based on the serial number and product key. To check for authenticity, the string may be generated locally and compared to the string read and/or decoded from the seal, as described above. The user thus checks that the label has not been copied.

The serial number, product key and the string or at least the associated hash value may be stored in an authentication database, which could be consulted in order to verify that the label has not been simulated, on, for example, unauthorized equipment. While the serial number/product key pairing may be copied and reproduced on counterfeit labels, the seal 800 provides a layer of security that essentially cannot be copied.

To verify that the label 50 has not been simulated a user first produces the one or more images. The user then manipulates the one or more images and, as appropriate, the serial number and product key to generate a string. The user then compares the generated string with the string included in the authentication database. Even if a counterfeiter could reproduce an accurate seal for the counterfeit label, the counterfeiter could not reproduce the seal, i.e., the string, that corresponds to the optical characteristics that are unique to the valid label. Thus, the saved string for the valid label and the generated string for the counterfeit label would not correspond.

As stated previously, markings 8 may comprise uni- or multi-dimensional barcodes and/or one or more machine or human-readable sequences of digits and/or characters. Alternatively, or in addition thereto, markings 8 may comprise one or more spread-spectrum markings wherein information from which the string, cryptographic signature of the string, and/or constituent portions thereof may be obtained, is “hidden”, and retrievable therefrom in accordance with the teachings of copending U.S. patent application Ser. No. 10/018,416, entitled “Data Encoding and Decoding” filed Dec. 14, 2001, and commonly owned with the subject application; the entirety of the disclosure of said copending application is incorporated into the subject application by reference. The markings may further represent machine printable and readable symbology, such as the angular symbology discussed above.

Registration marks 9 and 902 may be placed on the workpiece the manufacturer (i.e., prior to processing of the workpiece 1 by apparatus 30), using a conventional non-variable printing process, such as, offset, flexography, or intaglio printing. Alternatively, if appropriately modified, apparatus 30 may be configured to print the registration marks 9 at a predetermined location (i.e., the location that comprises portion 29), using printing mechanism 36. That is, the apparatus 30 may generate the images 47 and may then print marks 9 so as to delimit the portion 29 of the workpiece 1 from which the images 47 were generated. Further, if the apparatus 30 is appropriately modified, the images 47 may be of aspect appearances corresponding to a plurality of different portions of the workpiece 1, with each portion being in a predetermined location and/or orientation relative to the registration marks.

Depending upon the type of imaging device 46 used in apparatus 30, the device 46 may generate the images 47 by scanning the portion 29 in a direction from one predetermined registration dot (e.g., dot 22) to another dot (e.g., dot 24). Alternatively, if the device 46 comprises a linear array of photo-sensors or a single photosensing element, the device 46 may separately scan “strips” or contiguous two-dimensional regions of the portion 29 and may generate respective composite images from which the hash value may be generated. Also, the illumination strength (i.e., amplitude) of the beam R may be adjusted so as to be equal to an empirically-determined “optimal” illumination strength (i.e., an illumination strength that provides an image with a maximum contrast to noise ratio).

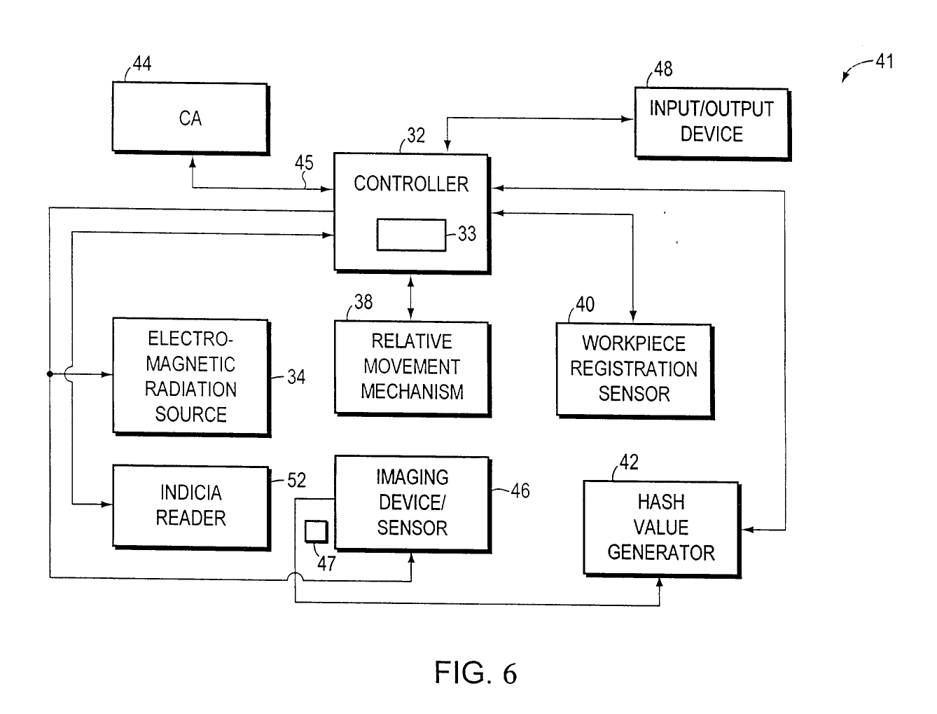

FIG. 6 is a functional block diagram of an apparatus 41 for validating/authenticating a workpiece purporting to have an indicium according to the first aspect of the present invention. It should be understood that, unless specifically stated to the contrary, the components and operation of like-numbered elements of apparatus 30 and 41 are substantially identical. Apparatus 41 generates the hash value by illuminating and imaging the workpiece 1 in the same way as apparatus 30. Once generated by generator 41, the hash value is supplied to controller 32 of apparatus 41. The controller 32 then stores the hash value in the memory 33. The controller 32 then causes indicia reader 52 (e.g., comprising a conventional optical scanning system) to scan the marks 8 and to generate therefrom a digitized image of the marks 8. The reader 52 then supplies the digitized image to the controller 32. Using conventional optical character and/or barcode recognition techniques, and/or the spread-spectrum information retrieval techniques from the aforesaid commonly-owned provisional application and/or angular symbology retrieval techniques from the aforesaid commonly-owned patent application, the controller 32 generates from the digitized image the string and/or cryptographic encrypted or encoded signature of the string that corresponds to or is represented by the marks 8.

The controller 32 then extracts from the generated string the hash value, a postage value and/or apparatus or product identification numbers concatenated therein. The controller 32 next compares the extracted hash value with the hash value stored in the memory 33, if the two hash values match to within predetermined thresholds, as discussed below, the controller 32 provides via the device 48, an indication that the workpiece 1 should be considered valid. If the two hash values do not match, the controller 32 provides the opposite indication.

Alternatively, or in addition thereto, the controller 32 may obtain from a certifying authority 44 a cryptographic key that is expected to be able to verify the signature (i.e., the remaining cryptographic key of the public/private key pair that was used to generate the cryptographic signature). The controller 32 of apparatus 41 may then use the retrieved cryptographic key to verify and decrypt the signature to obtain the string. The controller 32 then parses to obtain the hash value that is contained therein. The generator 41 next compares the retrieved hash value with the hash value that is stored in the memory 33. If the two hash values match, the controller 32 provides to a human operator via device 48 an indication that the workpiece should be considered valid. If the two hash values do not match, however, an opposite indication is provided by the controller 32 to the human user via the device 48. The controller 32 also compares the other information contained in the string (i.e., the postage value and apparatus or product identification number) with corresponding information that is known to be valid. The corresponding information may, for example, be supplied to the controller 32 by the operator via the device 48.

The controller may also retrieve a code word from an authentication database and determine if the code word is contained in the signature and/or the hash. Alternatively, the controller may compare the hash value with a hash value stored in an authentication database.

For purposes of the hash value comparisons made by controller 32, each hash value may be viewed as a feature vector, and each such comparison may be carried out in the following manner. First, the feature vectors are normalized and the normalized vectors are compared by obtaining an inner product that measures the angle between the vectors in a high dimensional feature space. An inner product value near +1 may be defined to indicate that the vectors are highly correlated, and thus, that they were created from the same underlying optically active aspects. An inner product below a set threshold may be defined to indicate the converse.

To overcome possible mis-registration, the two hash values may be compared taking into account possible offsets, and the highest resulting inner product correlation score may be used. Depending upon the device 46, the pixel brightness values of the digitized images from device 46 may consist of only positive values. This may cause these images to have large DC offsets, which may make this inner product comparison technique inaccurate. In order to improve the accuracy of this comparison technique, the zero spatial frequency component of the Fourier transforms (hereinafter termed “the DC offset”) of the images used to generate the compared hash values should be eliminated. Beyond eliminating the DC component, high pass filtering of the images (or appropriately selecting particular frequency components thereof) generated by device 46 and thresholding the brightness value associated therewith based upon an empirically determined threshold value may help to improve the accuracy of this technique. Other hash value comparison techniques may alternatively be used by controller 32 of apparatus 41.

For example, depending upon the hash value algorithm employed, instead of comparing the two hash values, the hash value obtained from marks 8 may be parsed and decompressed to obtain images that may be compared directly with the filtered images 47 generated by the system 41 (i.e., for correlation therewith). Advantageously, this comparison technique may improve comparison consistency and accuracy.

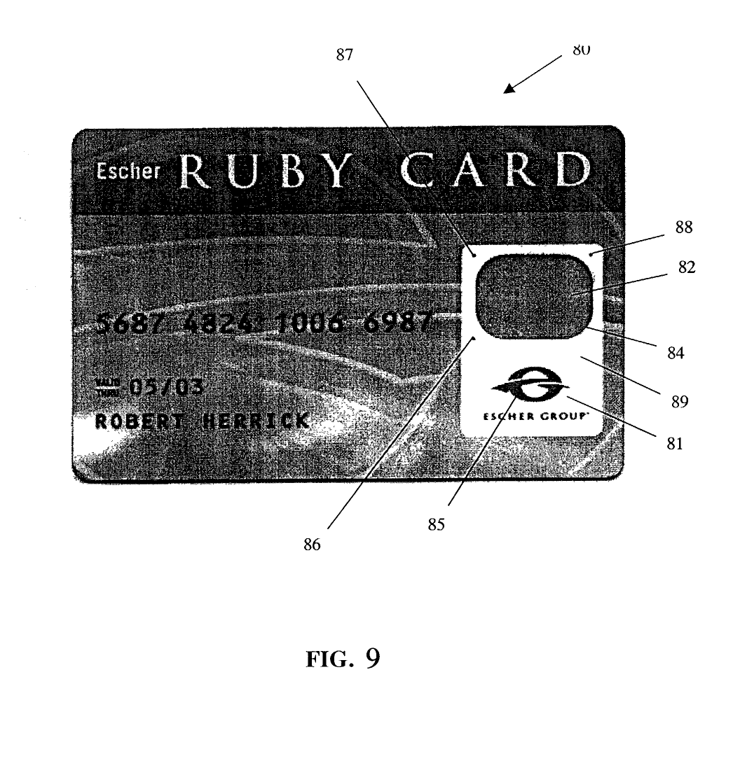

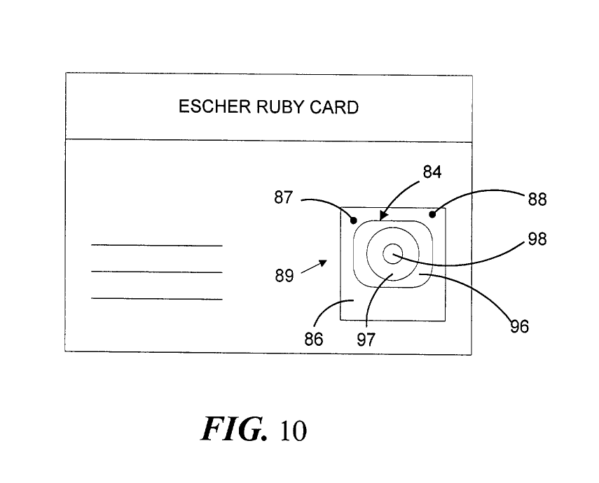

As discussed above, the optically active components may be the gems contained in gemstone dust. Referring now to FIG. 9, the gemstone dust 82 may be dispersed uniformly and randomly on or embedded in one or more portions 89 of a workpiece, such as a credit card 80. The gemstone dust is hard, and thus, long lived on the workpiece. One example is ruby dust, which is A1₂0₃ doped with Cr³⁺. Ruby dust is manufactured commercially for use in grinding wheels and so forth, and is thus readily available.

As depicted in the drawing, the ruby dust 82 is embedded in a portion 89 of the card 80 that is visible through a window 84. The card also includes registration features, such as dots 86, 87 and 88, which in the drawing are printed on the card in the top left, lower left and top right corners of the window. The gemstone dust may instead be included in a portion 89 as one or more patterns 85 that are imprinted on the surface 81 of the card 80 or embedded in the card 80 in one or more predetermined positions relative to the registration features.

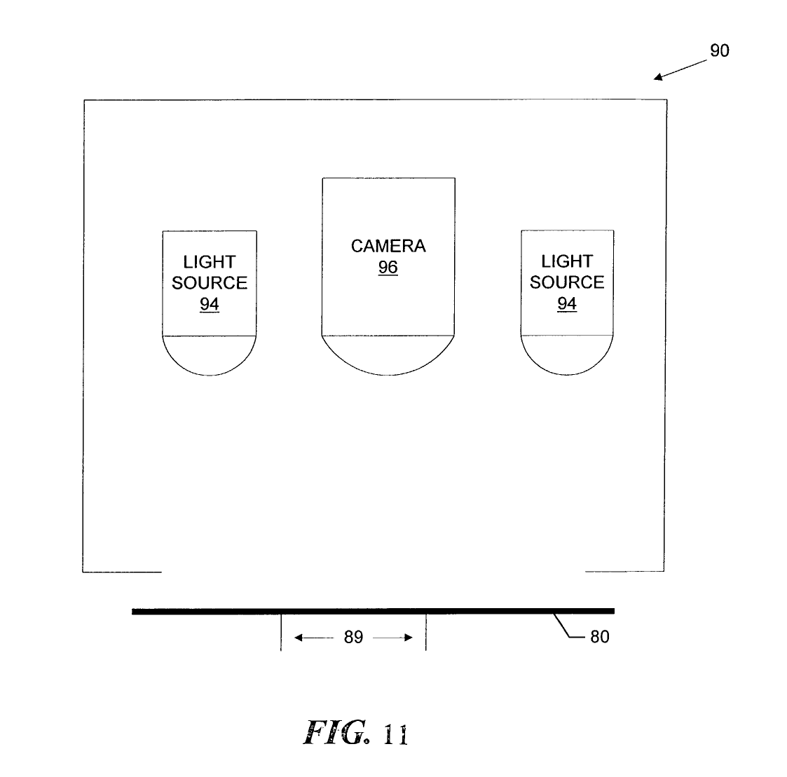

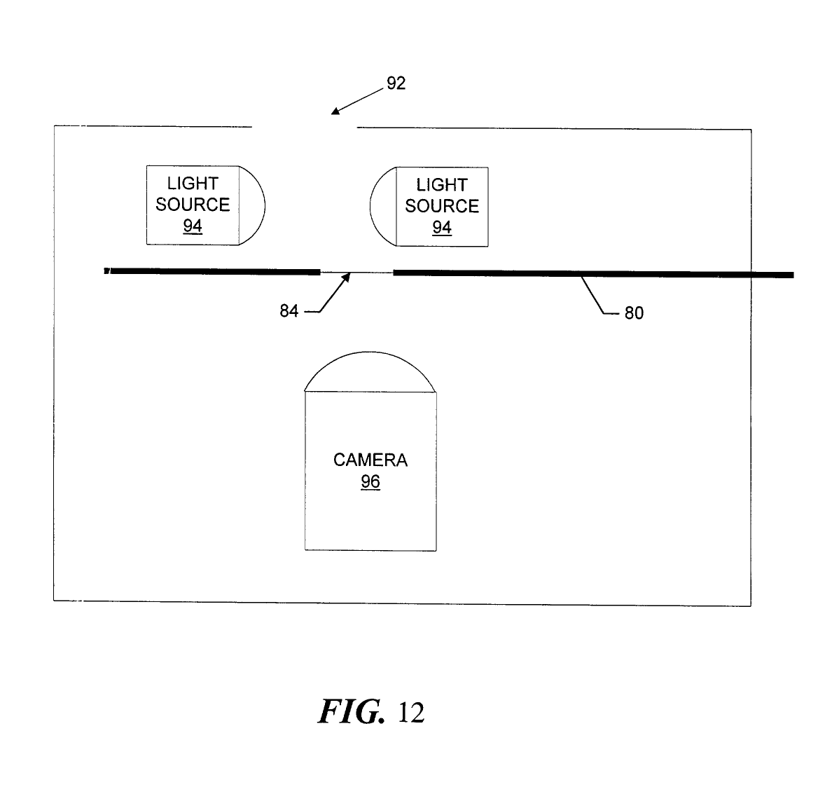

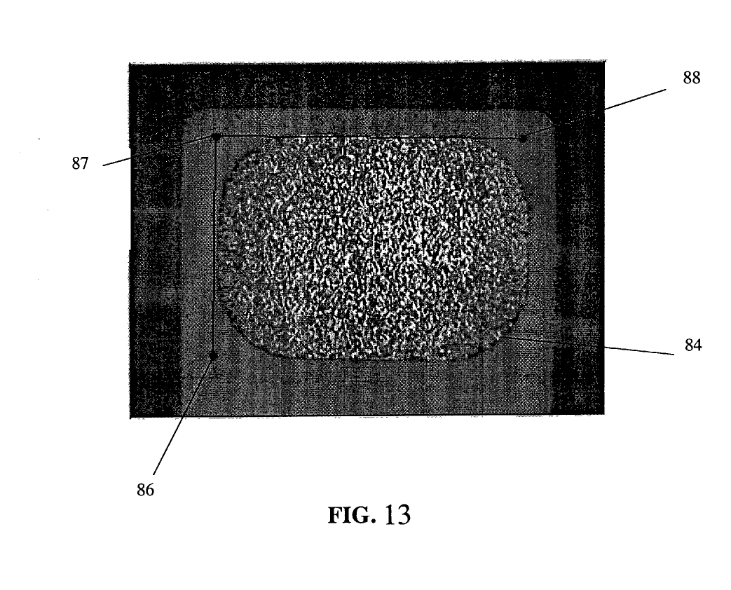

Referring also to FIG. 11, a verification device 90 includes light sources 94 that produce light in visible and/or ultraviolet (“UV”) wavelengths, and a camera 96 that produces the images 47. The light sources 94 illuminate the portion 89 of the card, in the example, all or certain sections of the window 84, with the sources 94 at selected positions relative to the window. The positions may represent various relative angles and/or orientations. If the window 84 extends through the card, or if the underlying substrate, i.e., the plastic card, allows light to pass through, the portion 89 may be illuminated instead or in addition from the rear of the card, as depicted in FIG. 12. The result of illuminating the portion 89 from the rear is depicted in FIG. 13, in which the various gems can be seen. The relative positions of the sources 94 must be consistent between the operations of generating the associated string and authenticating the card.

The gems in the gemstone dust, in the example, the ruby dust, may be fluorescent and thus emit light in the visible wavelength when excited by UV light. The gems in ruby dust, for example, emit red light. The dust may instead include a mixture of different types of gems, which emit light in various colors. Accordingly, a first step in authenticating the card may be illuminating the portion 89 with UV light and determining if light is emitted in the proper wavelengths.

Alternatively or in addition, the UV light may be used to reveal a pattern of gemstone dust in a non-fluorescent carrying medium that, in visible light, looks similar to the dust. Thus, for example, the ruby dust may be mixed into a carry medium of rubycolored glass or plastic, which is then included on or embedded in a substrate, i.e., the credit card 80. In visible light, the gems are “hidden” in the carrying medium. When carry medium is exposed to UV light, however, the presence of the gems therein is revealed as emitted light.

The gemstone dust may further be dispersed in one or more predetermined patterns in the carrying medium, such that a corporate logo, and so forth, appears in the emitted light when the carrying medium is illuminated with UV light. Alternatively, as depicted in FIG. 13, the gemstone dust may be uniformly distributed in the portion 89 and the patterns may be included in a window cover 96, such as an over laminate that has UV transmissive sections 97 and non-transmissive sections 98, which are strategically arranged. Accordingly, a first step in the authentication process 80 may be to illuminate the portion 89 with UV light, to determine if the one or more predetermined patterns are revealed. This step could be performed by machine or by a user, with workpieces that do not pass this first step determined to be invalid.

Once the first step of authentication is passed, i.e., once the patterns are revealed under UV light to the human and/or machine reader, the verification system proceeds with the remaining steps of producing and analysing the one or more images 47, and so forth, described above.

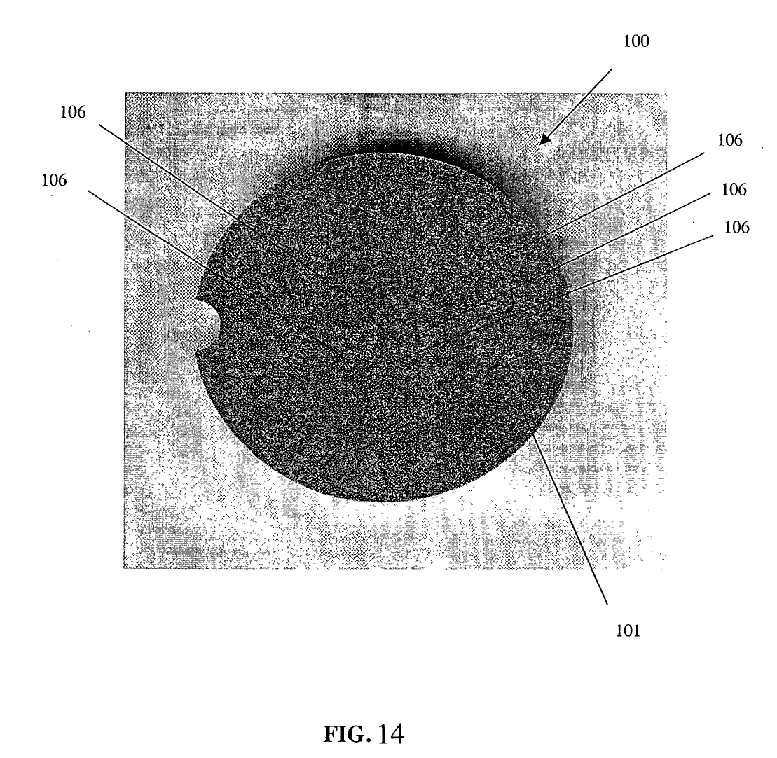

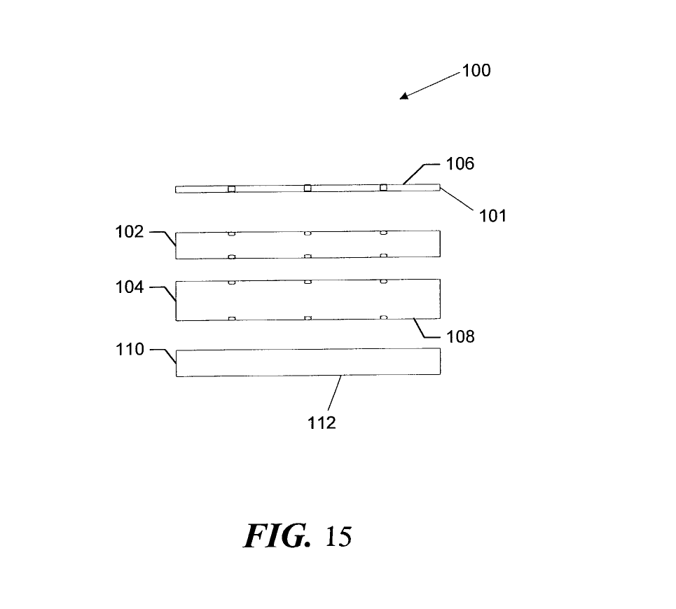

Referring now to FIGS. 14 and 15, a product, represented as a token 100, has a surface layer 101 that consists of a coating of an optically active medium. The medium, such as the optically variable ink, may be used to coat all or a portion of a surface of an underlayer 102, which in the example is a paper that is then glued to a plastic substrate 104, such as a white acrylic disk. Alternatively, the optically active medium or the components thereof may be applied to a surface in the underlayer by, for example, embedding flakes, gems, and so forth, in a clear laminate that is then used to coat a surface underlayer. Alternatively, the gems, flakes and so forth may be embedded directly into the substrate.

A plurality of registration marks 106 are included in or on the surface 101, to define the one or more portions 89. As shown in the drawings, the registration marks may be cut into the surface 101 and through the underlayer 102 and the substrate 104, and an opaque layer 110, in the example, a black paper, is thereafter attached, e.g., glued, to a bottom surface 108 of the substrate. The marks may instead be imprinted on the ink coating by, for example, thermal transfer ink jet, offset, flexography, itaglio, other nonvariable printing process. The indium used for authentication is then imprinted on the back surface 112 of the token, that is, on the paper which, in the example, is glued thereon. The indicium may, as appropriate, be printed on or engraved in the bottom surface 108 of the substrate. If the indicium is used for product identification, the indicium need not be included on the product. Instead, the indicium, string and/or hash value may be included in an appropriate database.

To authenticate the token, the verification device illuminates the portion 89 from appropriate angles to produce the images 47. Based on the images, the device produces an indicium, which the device or a person can then compares with the indicium printed on the back surface of the token. If the string and the imprinted indicium agree to within predetermined thresholds, the token is authentic. Otherwise, the token is deemed a counterfeit. The thresholds are set based on a trade-off between false validation and false rejections.

Thus, it is evident that there has been provided in accordance with the present invention, a workpiece authentication technique that fully satisfies the aims and objectives, and achieves the advantages hereinbefore set forth. It will be apparent to those skilled in the art that many alternatives, modifications, and variations of the foregoing illustrative embodiments are possible without departing from the present invention. For example, although the source 34 has been described as moving relative to the portion 30 such that source 34 is positioned at different orientations, relative to portion 30, if apparatus 30, 41 are appropriately modified, source 34 may instead move relative to portion 30 such that source 34 is positioned at the different angles, directions and/or orientations relative to the portion 30. The images 47 may then be generated when radiation R is emitted from the source 34 when source 34 is in these different positions.

For example, the source 34 may include multiple light source and/or fiberoptic light emission systems positioned at multiple orientations relative to the workpiece. These systems may be sequentially activated, or alternatively, may be activated simultaneously to provide illumination to the portion 30 from multiple angles/orientations/positions relative to the portion 30 simultaneously.

Also, apparatus 30 may be modified such that controller 32 may cause printer 36 to print on surface 11 markings representative of or corresponding to the hash value generated by generator 41. Such markings may comprise human-readable optical character recognizable sequences of digits, uni- or multi-dimensional barcodes, spreadspectrum markings and/or machine printable and readable angular symbology within which information from which the hash value may be obtained is hidden. Alternatively, the hash value may be provided to an end user from the manufacturer of the envelope via a mass storage memory device (e.g., floppy or optical disc encoded to store the hash value), electronic messages sent to the end user via a communications network, or via interaction with an object identification tag system wherein the hash value is stored (e.g., of the type disclosed in copending U.S. patent application Ser. No. 09/665,697, filed Sep. 20, 2000, entitled “Apparatus and Method For Obtaining Information Related to an Object”; this copending application is commonly owned with the subject application and is incorporated herein by reference in its entirety. The end user may then sign the hash value (or a concatenation of the hash value with other information, such as a user identification number and postage value) using a cryptographic key of the end user or of the certifying authority 44, and marks representative of or corresponding to the resulting signature may be placed onto surface 11 as marks 8 by a conventional printing system. Advantageously, the end user in this alternative arrangement need not employ an imaging device 46 and source 34 to generate the string and cryptographic signature. This may substantially reduce the cost and simplify the construction of the system used by the end user to generate marks 8. Also advantageously in this alternative, envelopes may be fabricated without preprinted postage values and valid postage may be obtained by the end user.

Additional modifications to the inventive system are also possible. For example, the device 46 may be integrated or comprised in printing mechanism 36 of apparatus 30. Alternatively, the device 46 may comprise a standalone type of imaging device (e.g., digital camera, scanner, etc.) and may include a database for storing the identifying string. Further, the registration sensor 40 may be comprised or integrated in the imaging device 46.

We have depicted that system as including a plurality of processors, such as the controller 32 and the imaging device 46. The processors may be combined into a single processor or arranged as various other groupings of processors. The instructions for the operations that the processors perform may be stored on memory resident on the respective processors, or on memory that is resident on certain of the processors and shared with or made available to other processors. Alternatively, the instructions for one or more of the operations may be made available to or communicated to the processors by, for example, the controller. Further, the system may store, transmit, print or otherwise provide the image to a user for decoding and/or authentication. Similarly, the image may be transmitted to or provided in hardcopy to be scanned into the system for decoding and/or authentication.

The system is readily implemented by means of one or more digital processors, either general purpose or special purpose. Conventional signal processing software and algorithms are readily applied to perform the requisite processing described herein.

The present invention enables a more definitive machine checkable security mechanism than simple appearance. The verification device can determine whether the particular detailed pattern of bright reflective or emitted highlights associated with the optically active medium on a workpiece is correct by comparing the pattern or, more precisely, a string generator from the pattern with an associated string printed on the workpiece or stored in an authentication database. Thus, workpieces with identical patterns printed using the optically variable inks can be uniquely identified and/or authenticated by the current device. Furthermore, using the current method of identification, it becomes possible to track individual articles, even though there may be no room on the product or document to print an identifier, such as a barcode, as is required with other machine checkable security mechanisms.

The present invention is intended to be viewed broadly, as encompassing all the alternatives, modifications, and variations that may be apparent to those skilled in the art, and as being defined only as forth in the appended claims.

What is claimed is:

1. An indicium for identifying a valid workpiece that includes an optically active medium on a surface of or embedded in at least one portion of the workpiece, the indicium, comprising a set of one or more markings corresponding to a string that is based upon, at least in part, intrinsic optical characteristics of optically active aspects of the optically active medium that is included on or embedded in the workpiece, the optical characteristics including one or more images associated with appearances of the optically active aspects when said at least one portion of said workpiece is illuminated with electromagnetic radiation from one or more illumination positions relative to said at least one portion.

2. The indicium according to claim 1 wherein the set of one or more markings corresponds also to a signature that is based upon a cryptographic key from a certifying authority, or an assigned codeword.

3. An indicium according to claim 1, wherein said one or more markings comprise at least one of the following on said workpiece: a barcode, a sequence of numeric or alphanumeric characters, a spread-spectrum marking, and angular symbology.

4. An indicium according to claim 1, wherein said workpiece comprises one of a postal mailpiece, a security label, a certificate of authentication, a credit/debit card, an identity card, and a product that includes the optically active medium as a coating or layer.

5. An indicium according to claim 1, wherein said workpiece comprises a postal mailpiece, and said string is also representative of a postage value associated with said mailpiece, if said workpiece is valid.

6. An indicium according to claim 5, wherein said indicium is imprinted on said mailpiece by an apparatus, and said string also identifies the apparatus, if said workpiece is valid.

7. An indicium according to claim 6, wherein said string is based upon respective numerical values representative of: one or more hash values representative of said characteristics, said postage value, and an identification value identifying said apparatus.

8. An indicium according to claim 1, wherein said workpiece comprises a card that includes information that identifies one or both of a user and a provider of the card or related services, and the string is further based, at least in part, on the information that identifies one or both of the user and the provider.

9. An indicium according to claim 1, wherein the illumination positions include one or more orientations, relative to the at least one portion of the workpiece.

10. An indicium according to claim 1, wherein a portion of the radiation is reflected from the at least one portion at an angle that is normal to a surface of the at least one portion, and the one or more images are generated from said portion of the radiation.

11. An indicium according to claim 1, wherein the radiation comprises one or both of ultraviolet light and visible light.

12. An indicium according to claim 1, wherein the optically active aspects are one or more of reflective flakes, gemstone dust gems, and features of a surface geomentry.

13. An indicium according to claim 1, wherein the at least one portion comprises a plurality of portions of the workpiece.

14. An indicium according to claim 1, wherein said string is based upon, at least in part, a concatenation of a plurality of numerical hash values derived from said one or more images.

15. An indicium according to claim 1, wherein said string is based upon, at least in part, differences between the one or more images.

16. Apparatus for use in generating a string for use in determining whether a workpiece is valid, comprising:
an electromagnetic radiation source for illuminating at least one portion of the workpiece with electromagnetic radiation from one or more illumination positions relative to said at least one portion;
an imaging device for generating one or more images of optically active aspect appearances of an optically active medium included on or embedded in said at least one portion when the at least one portion is illuminated with the radiation by the source at the one or more illumination positions; and
a string generator that generates the string based upon, at least in part, the one or more images.

17. Apparatus according to claim 16, further comprising a mechanism that marks the workpiece with a set of one or more markings corresponding to at least one of a signature, the string, and an encrypted representation of the string, the signature being based upon the string and an encrypted representation of the string and a cryptographic key of a certifying authority (CA) or an assigned codeword.

18. Apparatus according to claim 17, wherein said one or more markings comprise at least one of the following on said workpiece: a barcode, a sequence of numeric or alphanumeric characters, a spread-spectrum marking, and angular symbology.

19. Apparatus according to claim 17, wherein said workpiece comprises a postal mailpiece, a security label, a certificate of authentication, a credit/debit card, an identity card, and a product that includes the optically active medium as a coating or layer.

20. Apparatus according to claim 17, wherein said workpiece comprises a postal mailpiece, and said string is also representative of a postage value associated with said mailpiece, if said workpiece is valid.

21. Apparatus according to claim 20, wherein said one or more markings are imprinted on said mailpiece, and said string is also identifies the apparatus, if said workpiece is valid.

22. Apparatus according to claim 21, wherein said string is based upon respective numerical values representative of: one or more hash values representative of said appearance, said postage value, and an identification value identifying said apparatus.

23. Apparatus according to claim 16, wherein the one or more illumination positions include one or more orientations relative to the at least one portion of the workpiece.

24. Apparatus according to claim 16, wherein a portion of the radiation is reflected from the at least one portion at an angle that is normal to a surface of the at least one portion, and the one or more images are generated from said portion of the radiation.

25. Apparatus according to claim 16, wherein the radiation comprises one or both of ultraviolet light and visible light.

26. Apparatus according to claim 16, wherein the at least one portion comprises a plurality of portions of the workpiece.

27. Apparatus according to claim 16, wherein said string is based upon, at least in part, a concatenation of a plurality of numerical hash values derived from said one or more images.

28. Apparatus according to claim 16, wherein said string is based upon, at least in part, differences between the one or more images.

29. Apparatus according to claim 16, wherein said optically active aspects are one or more of reflective flakes, gemstone dust gems, and features of a surface geometry.

30. Method for generating a string for use in determining whether a workpiece is valid, comprising:
illuminating at least one portion of the workpiece with electromagnetic radiation from one or more illumination positions relative to said at least one portion;
generating one or more images of optically active aspect appearances of an optically active medium included on or embedded in said at least one portion when the at least one portion is illuminated with the radiation at the one or more illumination positions; and
generating the string based upon, at least in part, the one or more images.

31. Method according to claim 30, further comprising marking the workpiece with a set of one or more markings corresponding to at least one of a signature, the string, and an encrypted representation of the string, the signature being based upon the string and a cryptographic key of a certifying authority or an assigned codeword.

32. Method according to claim 30, wherein said one or more markings comprise at least one of the following on said workpiece: a barcode, a sequence of numeric or alphanumeric characters, a spread-spectrum marking, and angular symbology.

33. Method according to claim 31, wherein said workpiece comprises a postal mailpiece, a security label, a certificate of authentication, a credit/debit card, an identity card, and a product that includes the optically active medium as a coating or layer.

34. Method according to claim 31, wherein said workpiece comprises a postal mailpiece, and said string is also representative of a postage value associated with said mailpiece, if said workpiece is valid.

35. Method according to claim 34, wherein said one or more markings are imprinted on said mailpiece by an apparatus, and said string also identifies the apparatus, if said workpiece is valid.

36. Method according to claim 35, wherein said string is based upon respective numerical values representative of one or more hash values representative of said appearance, said postage value, and an identification value identifying said apparatus.

37. Method according to claim 30, wherein the one or more illumination positions include one or more orientations relative to the at least one portion of the workpiece.

38. Method according to claim 30, wherein a portion of the radiation is reflected from the at least one portion at an angle that is normal to a surface of the at least one portion, and the one or more images are generated from said portion of the radiation.

39. Method according to claim 30, wherein the radiation comprises one or both of ultraviolet light and visible light.

40. Method according to claim 30, wherein the optically active aspects are one or more of reflective flakes, gemstone dust gems, and features of a surface geometry.

41. Method according to claim 30, wherein the at least one portion comprises a plurality of portions of the workpiece.

42. Method according to claim 30, wherein said string is based upon, at least in part, a concatenation of a plurality of numerical hash values derived from said one or more images.

43. Method according to claim 30, wherein said string is based upon, at least in part, differences between the one or more images.

44. Computer-readable memory comprising computer-executable program instructions for use in generating a string for use in determining whether a workpiece is valid, the instructions when executed causing: illumination of at least one portion of the workpiece with electromagnetic radiation from one or more illumination positions relative to said at least one portion; generation of one or more images of optically active aspect appearances of an optically active medium included in or embedded on said at least one portion when the at least one portion is illuminated with the radiation at the one or more illumination positions; and generation of the string based upon, at least in part, the one or more images.

45. Memory according to claim 44, wherein the instructions when executed also cause marking of the workpiece with a set of one or more markings corresponding to at least one of a signature, the string, and an encrypted representation of the string, the signature being based upon the string and a cryptographic key of a certifying authority or an assigned codeword.

46. Memory according to claim 45, wherein said one or more markings comprise at least one of the following on said workpiece: a barcode, a sequence of numeric or alphanumeric characters, a spread-spectrum marking, and angular symbology.

47. Memory according to claim 44, wherein said workpiece comprises a postal mailpiece, a security label, a certificate of authentication, a credit/debit card, an identity card, and a product that includes the optically active medium as a coating or layer.

48. Memory according to claim 45, wherein said workpiece comprises a postal mailpiece, and said string is also representative of a postage value associated with said mailpiece, if said workpiece is valid.

49. Memory according to claim 48, wherein said one or more markings are imprinted on said mailpiece by an apparatus, and said string also identifies the apparatus, if said workpiece is valid.

50. Memory according to claim 49, wherein said string is based upon respective numerical values representative of: one or more hash values representative of said appearance, said postage value, and an identification value identifying said apparatus.

51. Memory according to claim 44, wherein the one or more illumination positions are one or more orientations relative to the at least one portion of the workpiece.

52. Memory according to claim 44, wherein a portion of the radiation is reflected from the at least one portion at an angle that is normal to a surface of the at least one portion, and the one or more images are generated from said portion of the radiation.

53. Memory according to claim 44, wherein the radiation comprises one or both of ultraviolet light and visible light.

54. Memory according to claim 44, wherein the optically active components are one or more of reflective flakes, gemstone dust gems, and features of a surface geometry.

55. Memory according to claim 44, wherein the at least one portion comprises a plurality of portions of the workpiece.

56. Memory according to claim 44, wherein said string is based upon, at least in part, a concatenation of a plurality of numerical hash values derived from said images.

57. Memory according to claim 44, wherein said string is based upon, at least in part, differences between the images.

58. An indicium according to claim 1, wherein the at least one portion is illuminated with the radiation simultaneously from different illumination positions.

59. An indicium according to claim 1, wherein the one or more images comprise a plurality of respective images of optically active aspect appearances of an optically active medium that is included in or embedded on the at least one portion resulting when the at least one portion is illuminated with the radiation from one or more illumination positions relative to the at least one portion.

60. An indicium according to claim 1, wherein the string is based upon, at least in part, a numerical hash value derived from the one or more images, the value being generated by a process that includes extracting from the one or more images one or more image portions, scaling the image portions to generate scaled image portions, averaging pixel values of scaled image portions to generate filtered images, and subtracting corresponding pixel values of the filtered images.

61. Apparatus according to claim 16, wherein the at least one portion is illuminated with the radiation simultaneously from different illumination positions.

62. Apparatus according to claim 16, wherein the string is based upon, at least in part, a numerical hash value derived from the one or more images, the value being generated by a process that includes extracting from the one or more images one or more image portions, scaling the image portions to generate scaled image portions, averaging pixel values of the scaled image portions to generate filtered images, and subtracting corresponding pixel values of the filtered images.

63. Method according to claim 30, wherein the at least one portion is illuminated with the radiation simultaneously from different illumination positions.

64. Method according to claim 63, wherein the one or more images comprise a plurality of respective images of the optically active aspect appearances of the optically active medium included in or embedded on the at least one portion resulting when the at least one portion is illuminated with the radiation from the respective illumination positions relative to the at least one portion.

65. Method according to claim 30, wherein the sting is based upon, at least in part, a numerical hash value derived from the one or more images, the value being generated by a process that includes extracting from the one or more images one or more image portions, scaling the image portions to generate scaled image portions, averaging pixel values of the scaled image portion to generate filtered images, and subtracting corresponding pixel values of the filtered images.

66. Memory according to claim 44, wherein at least one portion is illuminated with the radiation simultaneously from different illumination positions.

67. Memory according to claim 67, wherein the one or more images comprise a plurality of respective images of the optically active aspect appearances of the at least one portion resulting when the at least one portion is illuminated with the radiation from the respective illumination positions relative to the at least one portion.

68. Memory according to claim 44, wherein the sting is based upon, at least in part, a numerical hash value derived from the one or more images, the value being generated by a process that includes extracting from the one or more images one or more image portions, scaling the image portions to generate scaled image portions, averaging pixel values of the scaled image portions, and subtracting corresponding pixel values of the filtered images.

69. An indicium according to claim 1, wherein the one or more images are generated using one of a linear array of photosensing elements, a two-dimensional array of photosensing elements and a single photosensing element.

70. Apparatus according to claim 16, wherein the imaging device comprises one of a linear array of photosensing elements, a two-dimensional array of photosensing elements and a single photosensing element.

71. Method according to claim 30, wherein the one or more images are generated using one of a linear array of photosensing elements, a two-dimensional array of photosensing elements and a single photosensing element.

72. Memory according to claim 44, wherein the one or more images are generated using one of a linear array of photosensing elements, a two-dimensional array of photosensing elements and a single photosensing element.

73. An indicium according to claim 1, wherein the indicium uniquely identifies the workpiece.

74. Apparatus according to claim 16, wherein the string uniqely identifies the workpiece.

75. Method according to claim 30, wherein the string uniquely identifies the workpiece.

76. Memory according to claim 44, wherein the string uniquely identifies the workpiece.

77. A workpiece including:
an optically active medium embedded in at least one portion of the workpiece;
registration features located at predetermined positions relative to the at least one portion; and
a window through which to view the optical variable medium from one or both of a front side of the workpiece and a rear side of the workpiece,
wherein the workpiece is authenticated based on the appearances of optically active components of the optically active medium when the at least one portion is illuminated with one or both of visible light and ultraviolet light.

78. The workpiece according to claim 77 wherein the optically active medium is gemstone dust.

79. The workpiece of claim 78 wherein the gemstone dust is arranged in one or more patterns on the workpiece.

80. The workpiece of claim 78 wherein the gemstone dust is mixed with a non-fluorescent carry medium that in visible light has a similar appearance to the dust, the gemstone dust and the carry medium both being viewable through the window.

81. The workpiece of claim 80 wherein the gemstone dust is arranged in one or more patterns within the carry medium.

82. The workpiece according to claim 77 wherein the window includes a cover that has one or more patterns thereon, the patterns including arrangements of ultraviolet transmissive and non-transmissive portions of the cover, wherein the patterns are visible when the cover and window are illuminated with ultraviolet light.

83. A method for authenticating a workpiece
illuminating from a rear side of the workpiece an optically active medium included in or embedded on at least one portion of the workpiece;
producing one or more images of the appearances of optically active components of the optically variable medium;
generating a string based upon, at least in part, the one or more images; and
determining if the string corresponds to a previously generated string that is associated with the workpiece.

84. A method for authenticating a workpiece
illuminating with ultraviolet light an optically active medium included on or embedded in at least one portion of the workpiece;
determining if the illuminated at least one portion of the workpiece emits visible light in one or more predetermined patterns;
determining that the workpiece is not authentic if the visible light is not emitted in the one or more predetermined patterns;
if the patterns are emitted, producing images associated with appearances of optically active aspects of the optically active medium, and
determining if a string that is based, at least in part, on the images corresponds to an earlier generated string which is included on or associated with the workpiece.

85. The method of claim 84 further including the step of determining if the illuminated at least one portion emits light in one or more predetermined frequencies.

86. A workpiece including
a substrate layer with a top and a bottom surface;
a layer of an optically active medium applied over or embedded in the top surface of the substrate; and
registration marks embedded in or imprinted on the optically active medium layer.

87. The workpiece of claim 86 further including an opaque layer on the bottom surface of the substrate; and
the registration marks consist of holes through the optically active medium layer and the substrate layer, such that the opaque layer is visible through the holes.

88. The workpiece of claim 87 further including an indicium printed thereon, the indicium being based, at least in part, on appearances of optically active aspects of the optically active medium when at least one portion of the medium that is in a predetermined position with respect to the registration marks is illuminated with one or both of visible light and ultraviolet light.

89. The indicium of claim 1 wherein the workpiece is a security label or certificate of authenticity that is associated within a given product or document and the string is further based, at least in part, on information that identifies the given product or document.

90. Apparatus of claim 16 wherein the workpiece is a security label or certificate of authenticity that is associated within a given product or document and the string is further based, at least in part, on information that identifies the given product or document.

91. The method of claim 30 wherein the workpiece is a security label or certificate of authenticity that is associated within a given product or document and the string is further based, at least in part, on information that identifies the given product or document.

92. The memory of claim 44 wherein the workpiece is a security label or certificate of authenticity that is associated within a given product or document and the string is further based, at least in part, on information that identifies the given product or document.

93. An indicium according to claim 1, wherein the string is based upon, at least in part, a numerical hash value derived from one or more images, the value being generated by a process that includes filtering the one or more images to produce one or more filtered images.

94. An indicium according to claim 93, wherein the process further includes scaling the one or more images before the images are filtered.

95. Apparatus according to claim 16, wherein the string is based upon, at least in part, a numerical hash value derived from one or more images, the value being generated by a process that includes filtering the one or more images to produce one or more filtered images.

96. Apparatus according to claim 95, wherein the process further includes scaling the one or more images before the images are filtered.

97. Method according to claim 30, wherein the string is based upon, at least in part, a numerical hash value derived from one or more images, the value being generated by a process that includes filtering the one or more images to produce one or more filtered images.

98. Method according to claim 97, wherein the process further includes scaling the one or more images before the images are filtered.

99. Memory according to claim 44, wherein the string is based upon, at least in part, a numerical hash value derived from one or more images, the value being generated by a process that includes filtering the one or more images to produce one or more filtered images.

100. Memory according to claim 99, wherein the process further includes scaling the one or more images before the images are filtered.

101. A workpiece including
an optically active medium included in or embedded in at least one portion of the workpiece;
registration features located at predetermined positions relative to the at least one portion;
identification information that identifies one or both of the workpiece and an associated product or document;
an indicium that comprises a set of one or more markings corresponding to a string that is based upon, at least in part, the identification information and intrinsic optical characteristics of optically active aspects of the optically active medium that is included on or embedded in the workpiece.

102. Method for generating a string for use in determining whether a workpiece is valid
illuminating at least one portion of the workpiece with electromagnetic radiation from one or more illumination positions relative to said at least one portion;
generating one or more images of optically active aspect appearances of an optically active medium included on or embedded in said at least one portion when the at least one portion is illuminated with the radiation at the one or more illumination positions; and
generating a string based upon, at least in part, the one or more images and information that identifies one or both of the workpiece and an associated product or document.

103. Method for authenticating a workpiece
illuminating at least one portion of the workpiece with electromagnetic radiation from one or more illumination positions relative to said at least one portion;
generating one or more images of optically active aspect appearances of an optically active medium included on or embedded in said at least one portion when the at least one portion is illuminated with the radiation at the one or more illumination positions; and
generating a string based upon, at least in part, the one or more images and information that identifies one or both of the workpiece and an associated product or document.

104. The indicium of claim 1 wherein the string is encrypted.
